(19) United States
(12) Patent Application Publication
(10) Pub. No.: US 2005/0229395 A1
(43) Pub. Date: Oct. 20, 2005

(54) Ceramic rolling body for a rolling bearing, and process for producing it

(76) Inventors: Edgar Proschel, Schwebheim (DE); Christian Proschel, Wurzburg (DE)

Correspondence Address: OSTROLENK FABER GERB & SOFFEN, 1180 AVENUE OF THE AMERICAS, NEW YORK, NY, 100368403, US

(21) Appl. No.: 11/096,180

(22) Filed: Mar. 31, 2005

(30) Foreign Application Priority Data
Apr. 2, 2004 (DE) 10 2004 016 285.9

(51) Int. Cl. F27D 3/00

(52) U.S. Cl. 29/898.04; 29/898

(57) ABSTRACT

A ceramic rolling body for a rolling bearing comprising a blank produced in an individual mold and having an encircling roller lateral surface which merges, via two lateral transition radii into two roller end faces. To reduce the costs of producing this ceramic roller, the roller lateral surface and the roller end faces of the blank have a maximum grinding layer that exceeds the final shape of the ceramic roller of between 1 and 5 μm. A plurality of cavities are formed into the roller end faces to reduce diffusion time and save sintering material.

### FIELD OF THE INVENTION

The invention relates to a ceramic rolling body for a rolling bearing, in particular to a ceramic roller with an encircling lateral surface and end faces and to a process for producing a ceramic rolling body of this type.

### BACKGROUND OF THE INVENTION

Japanese laid-open specification JP 05-164132 discloses a ceramic roller of the type for use in a cylinder roller bearing. The roller has an encircling roller lateral surface which merges into two roller end faces via two lateral transition radii. According to the brochure published by FAG Kugelfischer KGaA “Hochleistungskeramik in FAG Wälzlagern” [High-performance ceramics in FAG rolling bearings], Publication No. WL 40 204 DA/80/11/90, pp. 19 ff., ceramic rollers of this type generally consist of a silicon nitride powder mixed with additives which promote densification. This powder is initially shaped into a rod-like blank in graphite press molds at temperatures of from 1700° C. to 1800° C. under mechanical pressure of from 30 to 50 MPa by one of reaction sintering, sintering, hot pressing or hot isostatic pressing. After drying of the blank, caused by diffusion between the sintering material and the furnace atmosphere, and cooling from the sintering temperature, this blank is divided into individual roller segments by diamond saw blades. The segments are then ground to their final shapes on their roller lateral surfaces and on their roller end sides and their transition radii using diamond grinding wheels. The thicknesses of material to be removed during grinding of the ceramic rollers, at least at the roller lateral surfaces of cylindrical rollers, are on both sides up to 0.3 mm on account of the tolerances which inevitably arise when using graphite press molds to sinter the ceramic blanks, and become correspondingly greater if the roller lateral surface of the ceramic roller is to be designed with a cone or barrel contour.

Therefore, it is drawback of ceramic rollers of this type that the costs of producing the ceramic blanks, which include the costs required for preparation of the powder, the costs of the press molds, the sintering installation and the sintering process, and the costs for the standard production in a clean room, are already extremely high. The costs of just producing the silicon nitride powder for the sintering process are higher by a factor of 50 to 100 than when using steel and in the case of solid ceramic rollers those costs already make up approximately 20% of the total production costs. Furthermore, in the case of solid ceramic rollers, the large material cross sections mean that relatively long diffusion times are required to dry the ceramic rollers, and these times therefore further increase the process costs. An additional factor is the cost incurred for the finish machining of the ceramic rollers. These costs include the costs of the diamond saw blades and of the diamond grinding tools and the costs for the machine service lives when cutting and in particular grinding the ceramic rollers. As a result, ceramic rollers of this type overall are extremely expensive to produce.

To at least partially reduce these high production costs, therefore, it is proposed in Japanese laid-open specification JP 07-305 727 to form a small concentric recess into each of the end faces of the ceramic roller. These recesses are either round in form and are optionally widened by radial curves or grooves, or are being designed as an annular groove or a polygon. Unlike in the case of the ceramic rollers described previously, the blanks for ceramic rollers or this type, however, are produced by sintering in graphite press molds with individual molds for each ceramic roller. This means that with these ceramic rollers, the costs required to cut rod-like blanks are eliminated. Furthermore, the recesses in the end faces of the ceramic rollers reduce the size of the areas to be ground at these end sides by the areas of these recesses. Consequently, the machine service lives for grinding the ceramic rollers and consequently the costs of finish machining for ceramic rollers of this type are reduced.

Despite these cost-reducing measures, however, ceramic rollers of this type likewise have the drawback that on account of the blanks being produced in graphite press molds which are subject to tolerances, the blanks are still formed relatively inaccurately, and at least at their roller lateral surfaces, the blanks can only be converted into their final shapes by expensive and time-consuming grinding work. Also, solid ceramic rollers of this type require large quantities of expensive ceramic powder. At the same time, on account of the large material cross sections within solid ceramic rollers of this type, long diffusion times are also required to dry the ceramic rollers. Consequently, the costs involved in producing the blanks for ceramic rollers designed with recesses of this type remain, as before, relatively high, which means that it is not possible to achieve significant savings on the production costs with ceramic rollers of this type either.

### OBJECT OF THE INVENTION

Working on the basis of the drawbacks of the solutions of the known prior art which are explained above, therefore, the invention is based on the object of providing a ceramic rolling body for a rolling bearing, in particular a ceramic roller, which makes it possible to minimize both the costs of producing the ceramic blanks and the costs of finish machining of the ceramic rollers.

### DESCRIPTION OF THE INVENTION

According to the invention, in a ceramic rolling body, the object of the invention is achieved by the fact that the roller lateral surface and the roller end faces of the blank have a maximum grinding layer which exceeds the final shape of the ceramic roller, of between 1 and 5 μm, and in addition, a plurality of cavities, which reduce the diffusion time and save sintering material, are formed in the roller end faces of the ceramic roller.

In an expedient refinement of the ceramic rolling body according to the invention, some of the cavities in the roller end faces are designed as axial centering bores which are formed into the roller end faces and are cylindrical in cross section, while others of the cavities are designed as ventilation bores, which are formed in each roller end face, coaxially with respect to the centering bores, and are cylindrical in cross section. The cross section of material within the ceramic roller is reduced both by the centering bores and by the ventilation bores in such a manner that the diffusion times for the blank to dry are considerably shortened with affecting the possible load-bearing capacity of the ceramic roller. At the same time, the volume of all the bores in the roller end faces constitutes the total volume of expensive ceramic powder which is saved as starting material for the ceramic roller.

Furthermore, an additional feature of the ceramic rolling body according to the invention is that the remaining material thickness between the centering bores and the ventilation bores and between the ventilation bores and the roller lateral surface is approximately equal. This is intended to avoid uneven diffusion times or diffusion rates when drying the blank, a criterion which also simultaneously defines the size and the depth of the individual bores and the number of the ventilation bores in the roller end faces.

With regard to the dimensions of the centering bores, it is proposed as a further feature of the ceramic rolling body according to the invention that, depending on the length and diameter of the ceramic roller, these bores have a bore diameter which corresponds to approximately 25% to 30% of the roller diameter and a bore depth which corresponds to approximately one third of the roller length. By contrast, in the case of the ventilation bores it has proven advantageous for these bores to have a bore diameter which corresponds to approximately 5% to 10% of the roller diameter and a bore depth which likewise corresponds to approximately one third of the roller length.

Finally, as the last feature of the ceramic rolling body according to the invention, it is also proposed that both the centering bores and the ventilation bores in the roller end faces are rounded at the bore entry and at the bore base. This has proven advantageous because it avoids sharp edges at and in the ceramic roller, which can lead to the formation of material cracks when the ceramic roller is under load.

The object of the invention is also achieved by a process for producing the described ceramic roller, according to which a ceramic powder which is known per se is first injected into corresponding individual molds of a multiple plastics injection-molding apparatus, and a plurality of ceramic rollers are simultaneously preformed and presolidified in this multiple plastics injection-molding apparatus. The vitrification and hardening of the preformed ceramic rollers then takes place in a separate firing furnace, and finally, after the ceramic rollers have been cooled, the roller lateral surface, the transition radii and the roller end faces are finish-treated by plunge-cut grinding.

In one specific form of the process of the invention, the individual molds in the middle plastics injection-molding apparatus include mandrels which are suitable for forming the centering bores and the ventilation bores in the roller end faces. These mandrels in each case define the dimensions of the bores which are matched to the roller length and the roller diameter and have all the rounded portions which are required to avoid material cracks. Then, in a further development of the process according to the invention, the preshaping and presolidification of the ceramic rollers in the multiple plastics injection-molding apparatus is preferably carried out at temperatures of from 200 to 300° C. and at pressures of from 30 to 50 MPa, so that the ceramic blanks are encapsulated in a gastight manner by the formation of an outer glass layer even after this treatment, and at that stage are already in their provisional final shape with all the radii at the roller lateral surfaces and at the roller end faces.

For the subsequent pressure-free vitrification of the ceramic rollers in a separate firing furnace, by contrast, in a further refinement of the process according to the invention, temperatures of from 1700 to 1800° C. have proven most favorable, since at temperatures of this level, the mechanisms which are known in connection with the sintering of ceramic powder are set in motion.

A last final feature of the process of the invention is also that the centering bores in the roller end faces of the ceramic blanks are simultaneously provided for the purpose of clamping the ceramic blanks between centering pins during their finishing treatment. This advantageously makes it possible to eliminate any imbalance in the ceramic blanks during the plunge-cut grinding of the roller lateral surfaces. To improve the clamping seat of the ceramic blanks between the centering pins, it may be advantageous for the rounded sections at the bore exit of the centering bores to be designed as conical depressions, each having a cone surface which merges into suitable radii at the start and at the end.

Therefore, the ceramic rolling body according to the invention has the advantage over ceramic rolling bodies known from the prior art that their production costs can be considerably reduced by forming centering and ventilation bores into the roller end faces. These centering and ventilation bores reduce the grinding surface area in a known way, with the associated savings in expensive and time-consuming grinding work. They also save large quantities of expensive ceramic powder. At the same time, these centering and ventilation bores reduce the cross section of the material in solid ceramic rollers in such a manner that the diffusion times for ceramic rolling bodies of this type are significantly shortened and consequently up to 50% of the production time is saved, compared to ceramic rolling bodies without centering and ventilation bores of this type. Furthermore, the process according to the invention for producing ceramic rolling bodies designed in this manner also considerably contributes to lowering the production costs thereof, since the ceramic blanks for the ceramic rollers are preformed in multiple plastics injection-molding apparatuses. On account of the lower thermal load, multiple plastics injection-molding apparatuses of this type do not have to be designed as graphite press molds, but rather can be produced from inexpensive tool steels with extremely high levels of accuracy of up to 1 μm. Consequently, it is possible to produce all surface shapes on known ceramic rolling bodies with virtually any desired final shape, which likewise saves on expensive and time-consuming grinding work during the finish machining of the ceramic rolling bodies or may even eliminate grinding work of this type altogether if the accuracy achieved for the ceramic blanks is already sufficient.

Other features and advantages of the present invention will become apparent from the following description of the invention which refers to the accompanying drawings.

### BRIEF DESCRIPTION OF THE DRAWINGS

A preferred embodiment of the ceramic rolling body designed in accordance with the invention is explained in more detail below with reference to the appended drawings, in which:

FIG. 1 shows an enlarged three-dimensional, perspective illustration of a ceramic rolling body according to the invention;

FIG. 2 shows a side view of a ceramic rolling body according to the invention;

FIG. 3 shows the cross-section A-A FIG. 2 through a ceramic rolling body according to the invention.

### DETAILED DESCRIPTION OF EMBODIMENTS OF THE INVENTION

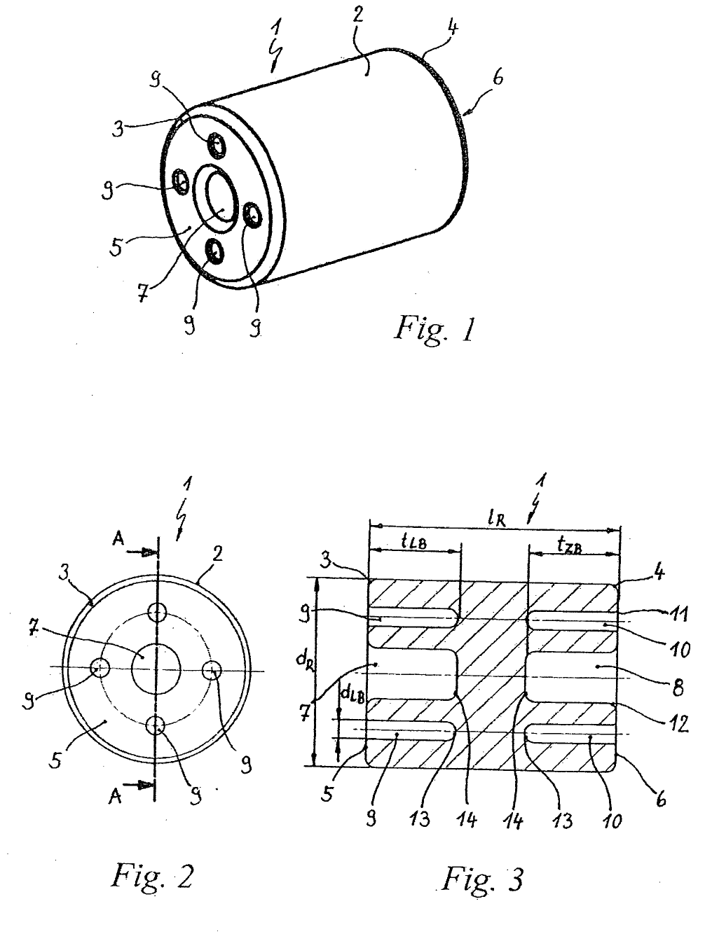

FIG. 1 shows a ceramic rolling body for a rolling bearing, which comprises a blank produced in an individual mold and designed as a cylindrical ceramic roller 1. The encircling roller lateral surface 2 of the roller merges radially inwardly via two lateral transition curved surfaces or radii 3, 4 into two roller end faces 5, 6. According to the invention, this ceramic roller 1 is distinguished by the fact that the roller lateral surface 2 and the roller end faces 5, 6 of the blank have a maximum grinding layer which exceeds the final shape of the ceramic roller 1 of between 1 and 5 μm, and that in addition a plurality of cavities 7, 8, 9, 10 which reduce the diffusion time and save sintering material are formed into and arrayed spaced around the roller end faces 5, 6.

FIGS. 1, 2 and 3 show that the cavities in the roller end faces 5, 6 comprise in part two centering bores 7, 8, which are in each case formed axially into the roller end faces 5, 6 and are cylindrical in cross section, and secondly four ventilation bores 9, 10, which are formed in each roller end face 5, 6, in each case coaxially with respect to the centering bores 7, 8 and are cylindrical in cross section. In addition to reducing the grinding surface area, with the associated savings on expensive and time-consuming grinding work, the bores also save large quantities of expensive ceramic powder, while at the same time reducing the material cross section of the ceramic roller 1 in such a manner that the diffusion time thereof is significantly shortened.

As indicated in FIG. 3, the centering bores 7, 8 have a bore diameter d_{ZB} which corresponds to approximately 25% to 30% of the roller diameter dR and a bore depth t_{ZB} which corresponds to approximately one third of the roller length l_{R}, while the ventilation bores 9, 10 have a bore diameter d_{LB} corresponding to approximately 5% to 10% of the roller diameter d_{R} and a bore depth t_{LB} corresponding to approximately one third of the roller length l_{R}. As a result, the material thickness which remains between the centering bores 7, 8 and the ventilation bores 9, 10 and between the ventilation bores 9, 10 and the roller lateral surface 2 is approximately equal, so that even diffusion times or diffusion rates are ensured when drying the blank.

Finally, it can also be seen from FIG. 3 that both the centering bores 7, 8 and the ventilation bores 9, 10 in the roller end faces 5, 6 are rounded at the bore entry 11, 12 and at the bore base 13, 14, so as to avoid sharp edges on and in the ceramic roller, which can lead to the formation of cracks in the material when the ceramic roller is placed under load.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A ceramic rolling body for a rolling bearing, comprising:
a ceramic roller comprising a blank produced in an individual mold,
an encircling roller lateral surface around the blank, the lateral surface having a respective lateral transition radius at each end thereof;
a respective roller end face at each end and into which the respective lateral transaction radius merges;
the roller lateral surface and the roller end faces of the blank have a maximum grinding layer that exceeds a final shape of the ceramic roller of between 1 and 5 μm; and
a plurality of cavities formed into the roller end faces to reduce diffusion time and save sintering material.

2. The ceramic rolling body as claimed in claim 1, wherein a first set of the cavities in the roller end faces are each an axial direction, cylindrical cross section, centering bore which is formed into one of the roller end faces.

3. The ceramic rolling body as claimed in claim 2, wherein a second set of the cavities in the roller end faces are each a cylindrical cross section ventilation bores which is formed into one of the roller end faces and is coaxial with respect to the centering bores.

4. The ceramic rolling body as claimed in claim 1, wherein a second set of the cavities in the roller end faces are each a cylindrical cross section ventilation bores which is formed into one of the roller end faces and is coaxial with respect to the centering bores.

5. The ceramic rolling body as claimed in claim 3, further comprising a remaining material thickness between the centering bores and the ventilation bores and between the ventilation bores and the roller lateral surface is approximately equal.

6. The ceramic rolling body as claimed in claim 5, wherein the centering bores have a bore diameter (d_{ZB}) which corresponds to approximately 25% to 30% of the roller diameter (d_{R}) and have a bore depth (t_{LB}) which corresponds to approximately one third of the roller length (l_{R}).

7. The ceramic rolling body as claimed in claim 5, wherein the ventilation bores have a bore diameter (d_{LB}) which corresponds to approximately 5% to 10% of the roller diameter and have a bore depth (t_{LB}) which corresponds to approximately one third of the roller length (l_{R}).

8. The ceramic rolling body as claimed in claim 5, wherein both the centering bores and the ventilation bores in the roller end faces are rounded at a bore entry at the end faces and at a bore base inside the blank.

9. A process for producing a ceramic rolling body wherein the body comprising:
producing a ceramic roller comprising a blank in an individual mold, the blank including
an encircling roller lateral surface around the blank, the lateral surface having a respective lateral transition radius at each end thereof;
a respective roller end face at each end and into which the respective lateral transaction radius merges;
the roller lateral surface and the roller end faces of the blank have a maximum grinding layer that exceeds a final shape of the ceramic roller of between 1 and 5 μm; and
forming a plurality of cavities formed into the roller end faces to reduce diffusion time and save sintering material;
the producing further comprising:
the producing comprising injecting a ceramic powder into corresponding individual molds of a multiple plastics injection-molding apparatus;
preshaping and presolidifying a plurality of ceramic blanks in the multiple plastics injection-molding apparatus such that they are nearly a final shape,
vitrifying and hardening the preshaped ceramic blanks without pressure in a separate firing furnace,
finishing treatment of the roller lateral surface, of the transition radii and of the roller end faces by plunge-cut grinding.

10. The process for producing a ceramic rolling body as claimed in claim 9, wherein the individual molds include mandrels which form both centering bores and ventilation bores in the roller end faces.

11. The process for producing a ceramic rolling body as claimed in claim 9, wherein the preshaping of the ceramic blanks in the multiple plastics injection-molding apparatus is performed at temperatures from 200° C. to 300° C. and at pressure from 30 to 50 MPa.

12. The process for producing a ceramic rolling body as claimed in claim 9, wherein the vitrification of the preshaped ceramic blanks in the firing furnace is performed at temperatures from 1700° C. to 1800° C.

13. The process for producing a ceramic rolling body as claimed in claim 9, further comprising providing the centering bores in the roller end faces of the ceramic blanks simultaneously for clamping the ceramic blanks between centering pins during a finishing treatment thereof.
